(19) United States
(12) Patent Application Publication
(10) Pub. No.: US 2024/0240621 A1
(43) Pub. Date: Jul. 18, 2024

(54) SYSTEM AND METHOD FOR HAPTICS USING SHAPE MEMORY MATERIAL

(71) Applicant: SMARTER ALLOYS INC., Cambridge (CA)

(72) Inventors: Mohammad Ibrahem KHAN, Cambridge (CA); Michael Lawrence KUNTZ, Cambridge (CA); Shahzad AHSAN, Cambridge (CA)

(21) Appl. No.: 18/289,613

(22) PCT Filed: May 9, 2022
(86) PCT No.: PCT/CA2022/050727

§ 371 Date: Nov. 6, 2023

Related U.S. Application Data
(60) Provisional application No. 63/185,485, filed on May 7, 2021.

(51) Int. Cl. F03G 7/06; G06F 3/01

(52) U.S. Cl. CPC F03G 7/066; F03G 7/06143; F03G 7/0615; F03G 7/067; G06F 3/016

(57) ABSTRACT

A haptic device that includes SMA components that drive the actuating mechanisms of the haptic device, such as haptic arms. When a current is passed through the SMA components, due to the multiple local transformation temperatures, different sections of the SMA components have different reactions to the current in order to drive the actuating mechanisms.

### CROSS-REFERENCE TO OTHER APPLICATIONS

The application claims the benefit of priority from U.S. Provisional Application No. 63/185,485 filed May 7, 2021 which is hereby incorporated by reference.

### FIELD

The present disclosure relates generally to haptic devices. More particularly, the present disclosure relates to a system and method for haptics using shape memory material.

### BACKGROUND

Haptic devices are used in many varieties of products and in many markets. These products use various types of actuators to stimulate the sense of touch. One of the main factors inhibiting the deployment of haptic technology is the cost. Additionally, the size and weight of many systems prohibits, or reduces, their range of use, limiting viable use scenarios such as take-home training for medical students and portable gaming/entertainment. Some important performance metrics common to haptic devices include the following: degrees of freedom (DOF); work volume; position resolution; continuous force ability; maximum force/torque; maximum stiffness; frequency; inertia and the like. Finding a balance among these parameters presents a challenge as current actuation mechanisms compromise on various metrics to improve upon others.

Electromagnet actuators can be used for haptic devices due to high achievable forces, low impedance and relatively simple, robust control algorithms. One of the large limitations of electromagnetic actuators is their low force density, significantly increasing their size and weight in order to increase achievable forces. Due to their increased weight, another limitation is their high endpoint inertia. This may be minimized by employing parallel rather than serial manipulator designs, or by integrating gearing. As a trade-off, gearing will add its own friction, inertia and backlash, compromising the impedance of the system. Furthermore, a continuous force is generally unachievable.

Compared to electromagnetic actuators, piezoelectrics have a higher force density, providing greater force with lower volumes. However, a limitation is the amount of actuation that can be achieved due to the fact that their mechanism relates to a principle of deformation. The application of piezoelectrics in haptics is typically limited to very small working spaces. Additionally, piezoelectrics have higher power supply requirements compared to electromagnetic actuators. Further limitations for piezoelectrics in the application of haptics include operating temperature, voltage and mechanical stress. Though these properties may be tweaked to an extent, costs and response times will typically be compromised.

Fluid that can change in viscosity when applying a magnetic field or electric current may sometimes be used as actuators for haptic devices. There are two main types of smart fluids—magnetorheological (MR) and electrorheological (ER), controlled by magnetic and electric fields, respectively. The main advantage of MR fluids is the large force that they can resist, however a large magnet is required which adds to a bulk of the system. The main advantage of ER fluids is the small size of the actuating elements relative to MR fluids. Smart fluids have a high force density, low inertia and negligible backlash. One limitation of smart fluid actuators is that the relationship between input current and output torque is non-linearly related with hysteresis, unlike electromagnetic actuators. This may be compensated for by implementing force/torque sensors, however this can drive up costs and add undesired friction, backlash and cogging to the actuators.

Therefore, there is provided a novel system and method of using haptics using shape memory material.

The above information is presented as background information only to assist with an understanding of the present disclosure. No determination has been made, and no assertion is made, as to whether any of the above might be applicable as prior art with regard to the present disclosure.

### SUMMARY

In a first aspect, the present disclosure provides a system and method for haptic devices that use shape memory materials.

One advantage of the current disclosure is an SMA controlled haptic device that improves upon at least one of the size, workspace, cost and force restrictions of current solutions. In particular, the system and method may use SMA actuators to control the force experienced at a stylus end effector, overcoming limitations of current technology such as backlash from a gearbox, inability to provide continuous force and high inertial losses. The system and method may be adapted for various applications, such as gaming, surgical training, teleoperation, remote equipment maintenance, or many other virtual reality applications. In some cases, the system and method can be adapted for use in a haptic glove, to provide even greater portability and immersion.

In one aspect, there is provided A haptics device including a set of haptic arms, each haptic arm including an actuating mechanism; a set of shape memory alloy (SMA) components, each of the set of SMA components connected to one of the set of haptic arms to drive the actuating mechanism; and a processor for communicating with each of the actuating mechanisms to actuate the set of haptic arms.

In another aspect, the set of SMA components include a SMA wire, a SMA bundle, a SMA spring or a thin SMA sheet. In another aspect, when a current is passed through a SMA component, at least one portion of the SMA component experiences a microstructural transformation and at least one other portion of the SMA component remains unchanged. In a further aspect, the haptics device further includes a set of cooling housings for cooling the set of SMA components. In yet another aspect, the haptics device further includes a set of positioning sensors for sensing a position of the set of haptic arms. In another aspect, the SMA components are a SMA wire or SMA bundle. In an aspect, the SMA wire bundle includes crimps or swages at at least one end of the SMA wire bundle. In another aspect, the SMA wire bundle includes a first portion and a second portion. In yet a further aspect, the haptics device further includes an electrical isolating component to isolate the first portion of the SMA wire bundle from the second portion of the SMA wire or SMA bundle.

In another aspect, the haptics device further includes an end effector, the end effector connected to at least one of the set of haptic arms. In yet another aspect, the haptics device further includes a stylus component connected to the end effector. In yet a further aspect, each of the set of haptic arms includes a proximal linkage; and a distal linkage. In another aspect, the set of SMA components are processed via multiple memory material technology to impart the multiple local transformation temperatures or enhance mechanical performance. In a further aspect, at least one of the set of SMA components includes multiple local transformation temperatures. In another aspect, one portion of a SMA component actuates upon heating and another portion of the SMA component provides sensing.

### DESCRIPTION OF THE DRAWINGS

Other aspects and features of the present disclosure will become apparent to those ordinarily skilled in the art upon review of the following description of specific embodiments in conjunction with the accompanying figures.

Embodiments of the present disclosure will now be described, by way of example only, with reference to the embedded Figures.

FIGS. 1a and 1b are schematic diagrams of shape memory material undergoing a multiple memory material process;

FIGS. 2a to 2c are schematic diagrams of a haptic device using shape memory materials;

FIG. 3 is a perspective view of the haptic device of FIGS. 2a to 2c;

FIG. 4 is a front view of a haptic device with arms in a delta formation;

FIG. 5 is a perspective view of a haptic arm;

FIGS. 6a and 6b are side and perspective views of how SMA material is connected to the haptic arm;

FIG. 6c is a flowchart outlining a method of actuating a haptics device;

FIG. 7 is a perspective view of a cooling housing;

FIG. 8a is a schematic view of airflow within a cooling housing;

FIG. 8b is a schematic cross-section of a view of a cooling housing integrated with a haptic arm;

FIG. 8c is a schematic view of a set of cooling housings integrated on actuator brackets;

FIG. 9 are a set of drawings of end effector mounts and stylus;

FIGS. 10a to 10c are perspective views of a housing for the haptic device; and

FIGS. 11a to 11h are different views of haptic glove.

### DETAILED DESCRIPTION

The following description with reference to the accompanying drawings is provided to assist in understanding of example embodiments as defined by the claims and their equivalents. The following description includes various specific details to assist in that understanding but these are to be regarded as merely examples. Accordingly, those of ordinary skill in the art will recognize that various changes and modifications of the embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used to enable a clear and consistent understanding. Accordingly, it should be apparent to those skilled in the art that the following description of embodiments is provided for illustration purpose only and not for the purpose of limiting the invention as defined by the appended claims and their equivalents.

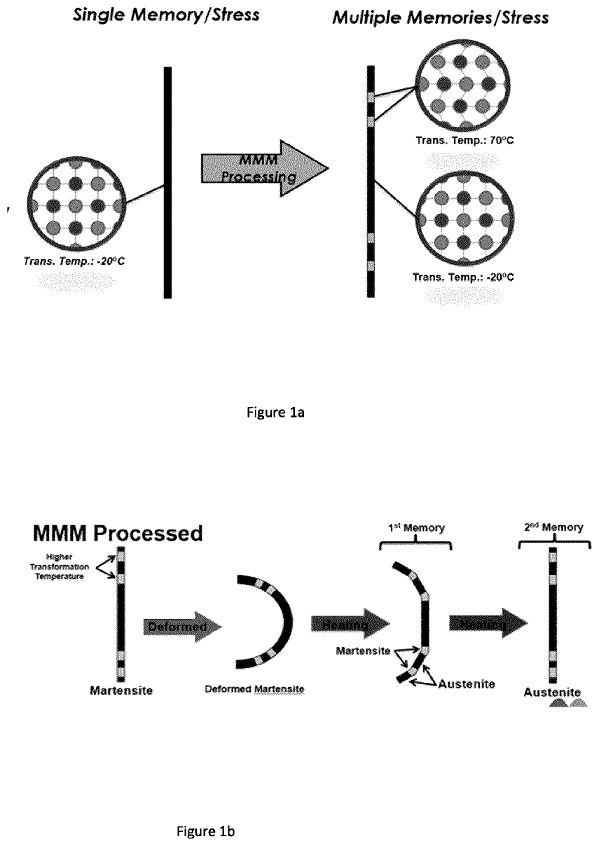

In the current disclosure, shape memory material is used to provide haptics to components. In some embodiments, the current disclosure uses shape memory material that may be processed by multiple memory material (MMM) technology such as described in U.S. Pat. No. 9,186,853, granted Nov. 17, 2015 which is hereby incorporated by reference. Examples of MMM processing or technology are schematically shown in FIGS. 1a and 1b. By applying MMM processing or technology to the smart memory material or smart memory alloy (SMA), precise tuning of local transformation temperatures within the SMA is enabled. This allows multiple transformation temperatures to be utilized for SMAs resulting in at least one of, a dynamic response from the SMA at distinct, or predetermined, temperatures, higher cycle life and/or the ability to enable sensing (such as force and displacement) within the SMA material. Specifically, MMM technology may be seen as a method for applying energy to a local area of a shape memory material to adjust the local structure and chemistry. The application of the MMM technology provides one or more additional transformation temperatures or modified pseudo-elastic properties of the treated local area. The remaining unaffected material still exhibits its original functional properties, which may include a linear elastic/plastic response such as in a fully cold worked condition. Hence, additional memories and properties can be realized in a monolithic SMA component, which in turn enables additional functionality. This makes it possible to fabricate a monolithic SMA that can operate passively in a wide range of temperatures.

SMAs have unique properties with two being the shape memory effect (SME) and pseudoelasticity (PE) of the SMA. The SME results from the ability of an alloy to transform from a rigid, high temperature austenite phase to a malleable, low temperature martensite phase during cooling. Once a high temperature shape is trained into an SMA component in the austenite phase, it can further be cooled to its martensite phase and deformed. When the material is cooled below a martensitic finish temperature (Mf), it is entirely martensite and easily deformed. Upon heating the SMA above an austenitic finish temperature (Af), the material becomes entirely austenite and returns to its trained shape, exhibiting large forces. Depending on the SMA's composition and historical thermomechanical processing, the functional high temperature phase may be the R-phase or any other phase.

Embodiments of the system and method herein are intended to provide improvements in position sensing, for example, sensing change in radius of linkages to determine translation of end effector, applying MMM to shape memory material to sense the resistance based on position; provide improvements in SMA wire bundles comprised of very thin wires to achieve high frequency actuation; provide air channels to precisely control cooling of SMA bundles; and the like, as described herein. Table 1 below provides a table showing how use of SMA being treated by MMM technology in haptics technology improves over current solutions:

| Current Solution | |
|---|---|
| Limitation | SMA Comparison |
| Weight | SMAs can have an extremely large force to weight |
| | ratio, reducing overall weight of the actuator |
| Force output | Higher force to weight ratio allows SMAs to |
| | exert higher continuous force |
| Cost | Fewer necessary components and smaller volume of |
| | material reduces cost of system |
| Frictional losses | Fewer mechanical components compared to |
| | electromagnetic drives, reducing resultant |
| | friction and wear |

In some embodiments, utilizing SMAs as the actuation driver can provide the potential to overcome some of the limitations of current technology, such as, but not limited to, electromagnetic drives. A constant force can generally be applied for an extended period of time, the size and weight of the system can be reduced significantly, and in turn, inertial forces and losses can be minimized or reduced. As an example, results of testing of a particular embodiment yielded a force range of 0-53N, a system friction of less than 0.1N, an actuation frequency of 3 Hz and a position resolution of <0.025%.

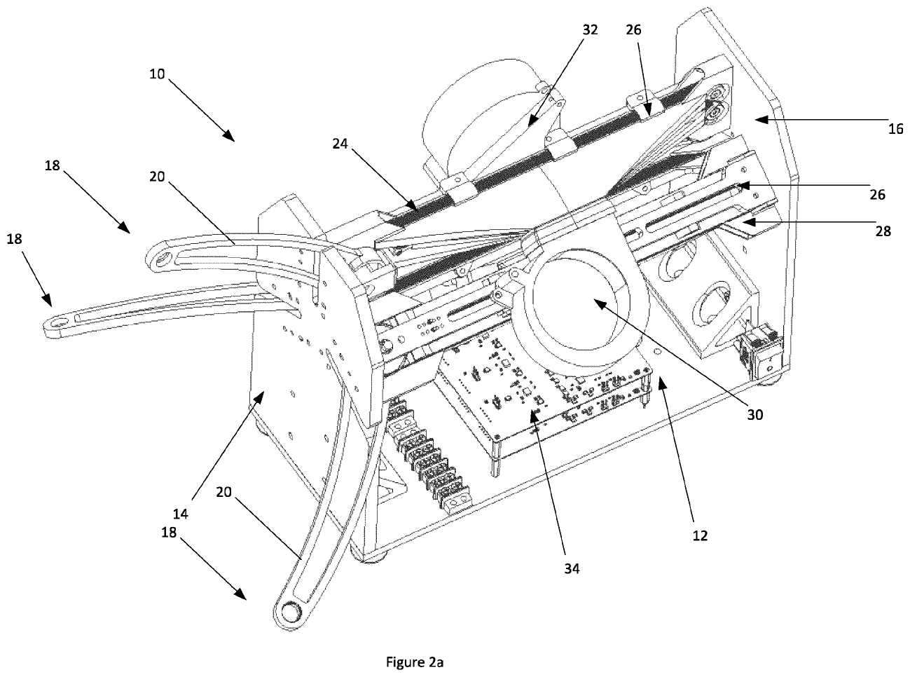

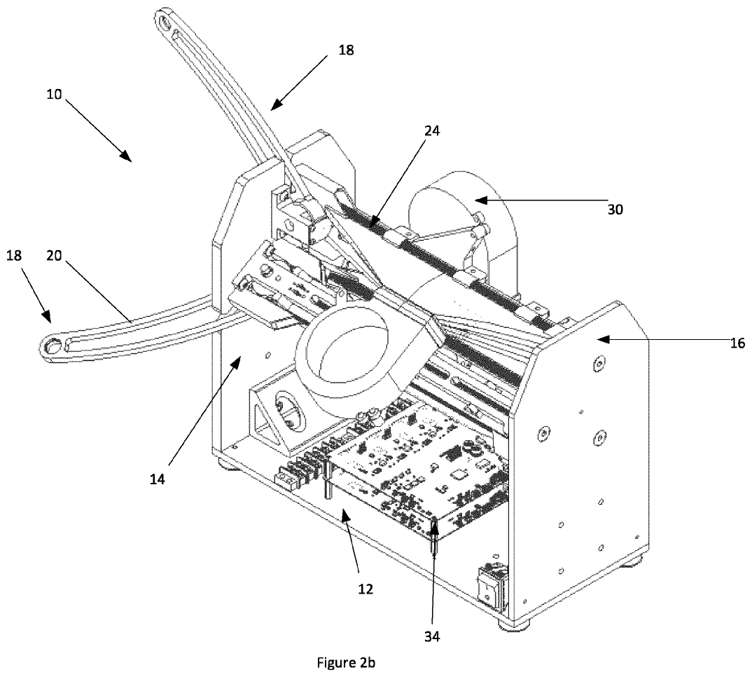

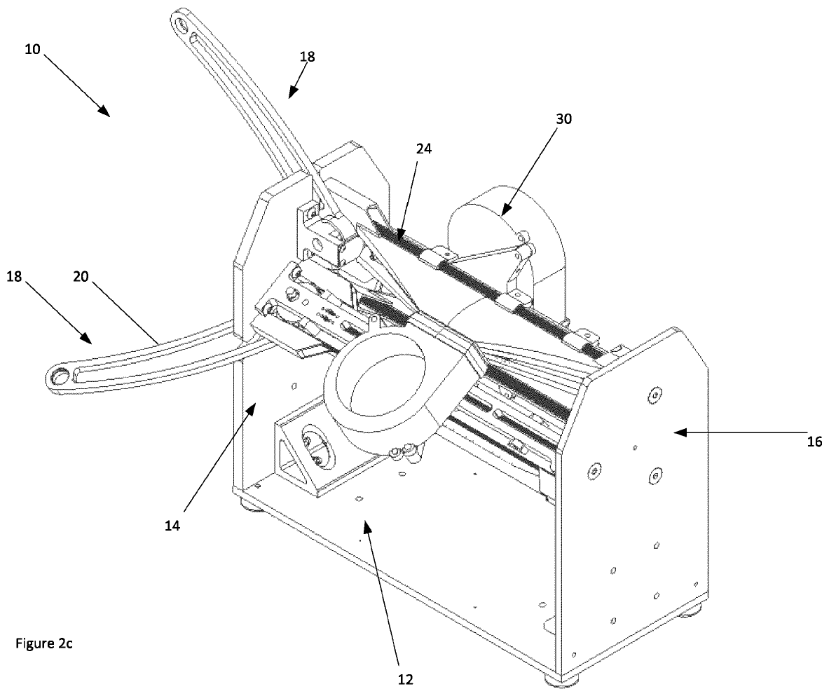

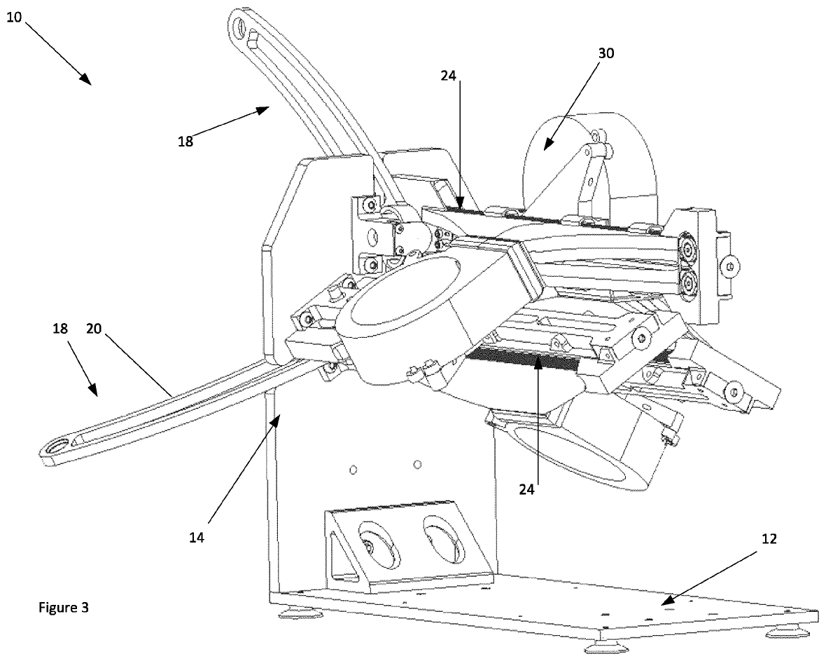

FIGS. 2a to 2c show one embodiment of an assembled haptic device where FIG. 2a is a front perspective of the haptic device with proximal linkages of the haptic arms visible, FIG. 2b is a rear perspective of the haptic device with proximal linkage of the haptic arms visible and FIG. 2c is a rear perspective view of the haptic device with proximal linkage of haptic arms visible and electronics removed. FIG. 3 is a schematic diagram of a haptic device with a rear portion removed so that the actuator assembly can be more clearly shown.

In the embodiment illustrated in FIGS. 2a to 2c and FIG. 3, a housing of the device 10 includes a base 12, front plate 14 and back plate 16, which are secured together and act as the frame on which the rest of the components of the haptic device can be mounted or installed. As shown in FIGS. 2a to 2c, the components can be housed within the shell with a portion (the proximal linkages) of the haptic arms 18 protruding out of the front plate 14.

In FIGS. 2a to 2c and FIG. 3, only the proximal linkages 20 of the haptic arms 18 are shown outside the housing or shell. FIG. 5 provides a perspective view of a full haptic arm 18 including the proximal linkages 20 and distal linkages 22 that make up each of the three haptic arms 18.

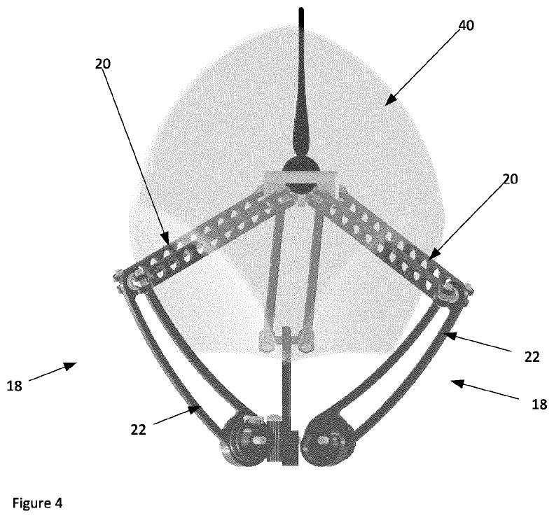

In the current embodiment, the three haptic arms 18 are oriented in a delta formation or configuration (which is more clearly shown in FIG. 4). A delta formation allows the actuators to be housed on the base 12 of the device 10 thereby reducing the weight of the haptic arms 18. Additionally, the cost and manufacturing complexity is relatively low as each of the three haptic arms 18 can be made identical. The delta formation also offers precision in terms of position compared to serial manipulator designs, as errors are shared by each of the linkages rather than added. In the current embodiment, the device 10 further includes SMA components, such as in the form for wire bundles 24 (made up of this SMA wires) that are wrapped around a base of the proximal linkage 20 and individually secured to individual actuator brackets 26 or actuation mechanisms. SMA components may also include, but are not limited to, a SMA spring, a SMA tube or a thin SMA sheet.

In operation, the SMA wire bundles 24 may function or operate as a driver for the actuating mechanism. In order to cool the SMA wire bundles 24, each actuator bracket 26 can have a cooling housing 28 attached to it. Details with respect to the cooling housing 28 are discussed below. Although not shown, the device also includes electrical components for supplying current to the SMA wire bundles.

Each cooling housing 28 links the SMA wire bundles 24 to a fan 30. In an alternative, other sources, or methods, of cooling such as, but not limited to, glycol channels or the like may be employed. Alternatively, a high temperature SMA may be employed to eliminate, or reduce, the need for active cooling such that ambient temperatures may be sufficient to cool the SMA wire bundles 24 and achieve high frequency actuation. In the current embodiment, the fans 30 are mounted in place by fan mounts 32 that attach to the adjacent actuator bracket 26.

The SMA wire bundles 24 are electrically connected to a control board 34, or processor, which regulates the current supply to each of the three SMA wire bundles 24 based on the detected position of the haptic arms 18. In use, if an object is encountered by the haptic device in virtual space, the combination of the three actuators allows for the force to be experienced in three degrees of freedom (DOF).

FIG. 4 is a schematic diagram of a set of haptic arms in a delta formation with end effector and workspace shown. Due to the nature of the delta formation, the workspace 40 is generally dome-shaped with a larger area at the base of the workspace. One benefit of this is that it is larger in the base of the work volume. The base of the stylus (the spherical portion) is able to translate and rotate freely within the bounds of the workspace.

The size of the workspace can be dictated by the length of the proximal linkages 20 and distal linkages 22 and the usable strain of the SMA wire bundles 24. There is a balance between optimizing, or improving, the workspace and minimizing, or reducing, the weight of the system, as more material is required not only to lengthen the haptic arms 18 but also to strengthen them. Increasing the length of the proximal 20 or distal 22 linkages will directly increase the workspace at the cost of reducing the resultant forces.

In operation, when the stylus is manipulated by a user, the movement of the stylus is sensed by the haptic arms which translates this sensed motion and transmits signals representative of the sensed motion to a processor such that the processor can then translate this sensed motion on a display to the user.

In one embodiment, high-quality, low-friction bearings can be used in each of the joints of the haptic system. To reduce inertial forces, the weight of the haptic arms 18 and end effector are minimized, or reduced, to every extent possible. In some embodiments, since the actuators remain in the base of the unit such as in the delta formation design, the weight of the actuators is less of a concern or not as big a factor in haptic device design compared with current solutions. The reduced weight of the SMA actuators in the disclosure compared to other technologies, such as electromagnetic actuators, helps to improve the overall portability of the system.

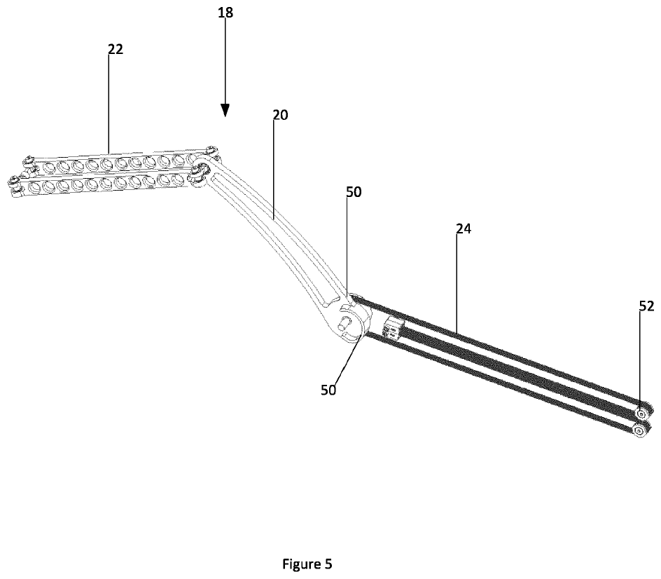

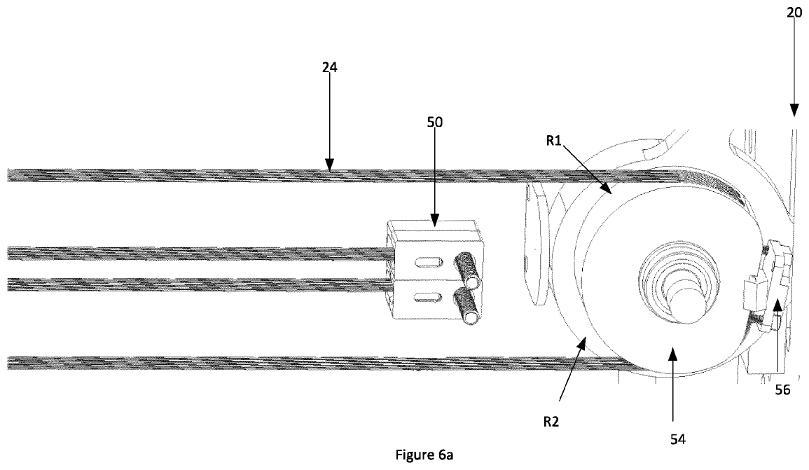

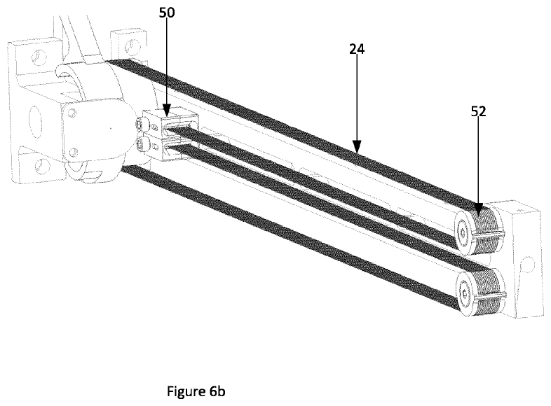

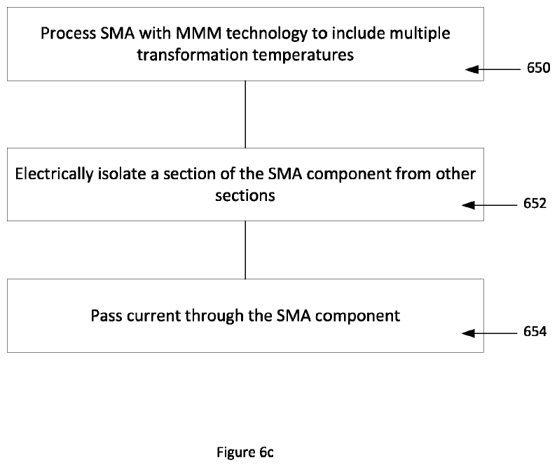

FIG. 5 is a schematic diagram of a haptic arm with SMA wire routing within each haptic arm 18. The SMA wire bundles 24 actuate the haptic arms to control a positioning of the haptic arm 18. Further details are shown with respect to FIGS. 6a and 6b which are schematic diagrams showing inductive sensing to determine an angle of a distal linkage. FIG. 6a is a close up schematic diagram showing a radial profile of distal linkage and FIG. 6b is a schematic diagram showing a full SMA wire assembly and inductive coil.

In one embodiment, the SMA wire bundles 24 controlling the position of the haptic arms 18 are made up of multiple SMA wires with crimps 50 on either end to create a single actuating unit. In other embodiments, the SMA wire or SMA bundle may include swages at either end. In one embodiment, the wires may be very thin (approximately 150 um diameter or less) to allow for rapid actuation and cooling. In some embodiments, each SMA wire bundle 24 may include up to 20 or more individual wires. In an alternative embodiment, a single SMA wire may be used, or alternative forms of SMA material such as a thin sheet, a tube or a spring. In a thin sheet form, the material may be further cut into thin slits using non-thermal cutting processes (e.g. femtosecond laser or electrical discharge machining (EDM)) to preserve the functional properties of the SMA.

The crimps 50 shown in FIGS. 6a and 6b can be mounted together. In some embodiments, the crimps 50 may be covered with an electrically resistive material such that they are electrically isolated. In other embodiments, the crimps 50 may be made of stainless steel or aluminum. Use of the crimps 50 improves an ability for the SMA bundles to be connected with other components of the haptic device and provides connection advantages over other systems.

In the current embodiment, the SMA wire bundles 24 wrap around two SMA pulleys 52 to allow for a larger usable strain (longer wire) while minimizing, or reducing, the length of each SMA wire required for the overall system. To help keep the SMA wire bundles 24 in place and avoid tangling, each of the wires may be fit through a small channel on the SMA pulley 52 prior to crimping the SMA wire bundle 24 ends.

As shown in FIG. 6a, the SMA wire bundles 24 wrap around a radial protrusion 54 on the proximal linkage 20 and interfaces with a ground connector 56 that rigidly connects to the proximal linkage 20. The SMA wire bundle 24 may be seen as including at least two portions which may or may not be the same size i.e. two halves. The ground connector 56 electrically isolates a portion, such as each half, of the SMA wire bundle 24 such that it can be antagonistically actuated. When current is supplied via one of the crimps 50, the current passes through the wire bundle until it reaches the ground connector 56, actuating a first portion, such as half of the SMA wire bundle 24 (causing an austenitic transformation), while the other, or second, portion, which may be the other half, of the SMA wire bundle 24 remains in the cooled martensitic state. The antagonistic biasing is intended to remove the need for an external bias (such as a spring or deadweight) for the SMA actuators.

The radial protrusion 54 has a variable radius profile, such that the radius starts at one dimension at R1 and increases to a larger radius at R2 (FIG. 6A). A small inductive coil can be rigidly mounted beside the radial protrusion 54. As the angle of the proximal linkage 20 changes, the distance between the inductive coil and the radial protrusion 54 changes, resulting in different inductance values. The inductive values can be mapped to the translational position of the haptic arms 18 to provide a reliable position sensor for three DOF. In an alternative embodiment, MMM laser processing, such as disclosed in US Patent Publication No. 20180347020 entitled METHODS AND SYSTEMS FOR PROCESSING MATERIALS, INCLUDING SHAPE MEMORY MATERIALS; US Patent Publication No. 20170165532 entitled MULTIPLE MEMORY MATERIALS AND SYSTEMS, METHODS AND APPLICATIONS THEREFOR; and US Patent Publication No. 20190264664 entitled SHAPE MEMORY ALLOY ACTUATOR WITH STRAIN GAUGE SENSOR AND POSITION ESTIMATION AND METHOD FOR MANUFACTURING SAME (which are all hereby incorporated by reference) may be used as an embedded strain gauge to achieve position sensing.

Turning to FIG. 6c, a method of actuating a haptics device that uses SMA components that may or may have been MMM treated to include multiple transformation temperatures or to enhance mechanical performance is shown. Initially, the SMA is treated or processed via MMM technology so that the SMA includes multiple transformation temperatures (650). It is understood that this may not necessarily be part of the method of the disclosure as the haptics device may use SMA components that have been previously MMM treated or processed or may use SMA components that are not MMM treated or processed.

The MMM treatment of the SMA causes the SMA component to have different portions that may react differently to different applied temperatures or currents. In other words, the SMA component may be seen as being made up of multiple portions or sections. At least one section of the SMA component is then electrically isolated from other sections of the SMA component (652). When a movement is sensed, current is passed through the SMA components (such as SMA wire bundles) (654). As the current passes through the SMA components, it will pass through a portion of the SMA component until it reaches the electrically isolating component, such as a ground connector 16, actuating that portion of the SMA component (causing an austenitic transformation), while the other portion or portions of the SMA component remains in a cooled martensitic state. It is understood that based on a design of the SMA components, there may be one or more portions that actuate in response to the applied current and one or more portions that do not react or actuate in response to the applied current. In some embodiments, the SMA component may include a sensing portion or may itself perform a sensing functionality. In some cases, the hot and cold phase may be different from austenite and martensite and include phases such as R-phase depending on the composition and thermomechanical history of the alloy.

In another embodiment, when current is passed through a SMA component (causing heating), at least one portion of the SMA component experiences a microstructural transformation and at least one other portion of the SMA component remains unchanged.

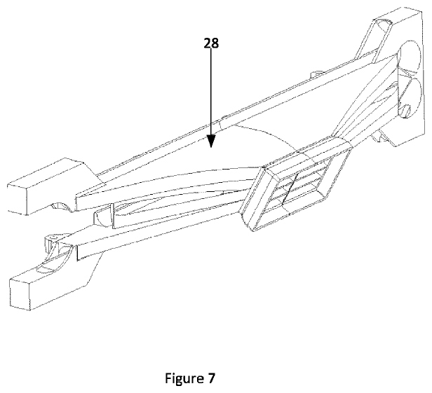

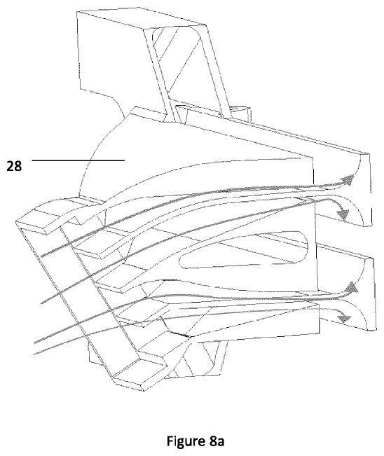

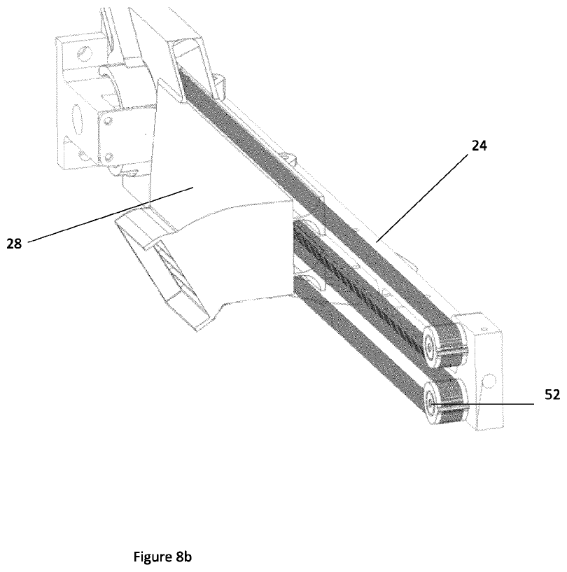

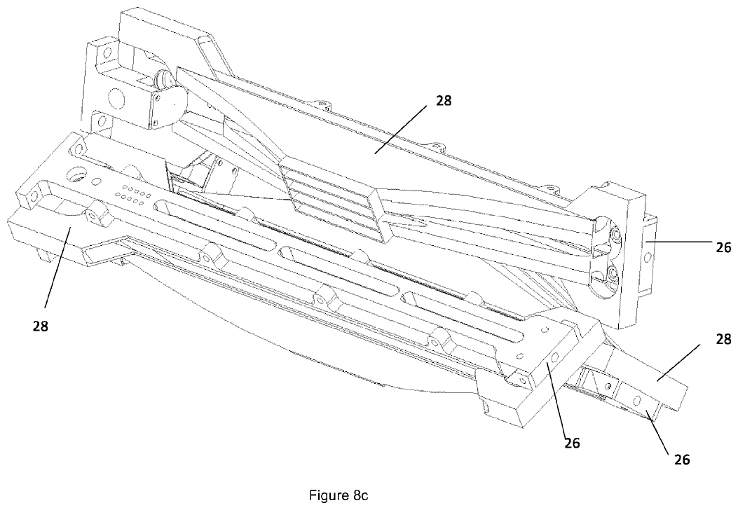

FIG. 7 is a schematic view of a cooling housing and FIGS. 8a to 8b are different cross-sections of the cooling housing. FIG. 8a is a cross-section of the cooling housing showing airflow and FIG. 8b is a cross-section of cooling housing attached to a single actuator assembly to show SMA wire routing. FIG. 8c shows a set of three cooling housings assembled on actuator brackets.

The cooling housing 28 is attached directly to the output of the fan 30 and acts to control the flow of air to the SMA wire bundles 24. FIG. 8a shows a cross-section of the cooling housing 28 with dedicated air channels for each pass, which in the current embodiment is four, of SMA wires in the SMA wire bundle 24. The cooling housing 28 may be made out of a plastic material to provide some structural integrity while minimizing, or reducing weight. The geometry of the channels allow for near-uniform cooling of the SMA wire bundles 24.

Some embodiments use active cooling with the fan 30 constantly supplying air to the cooling housings 28 while the haptic device is in use. As described herein, cooling via glycol channels or the like may be used in alternative embodiments to minimize, or reduce, the noise.

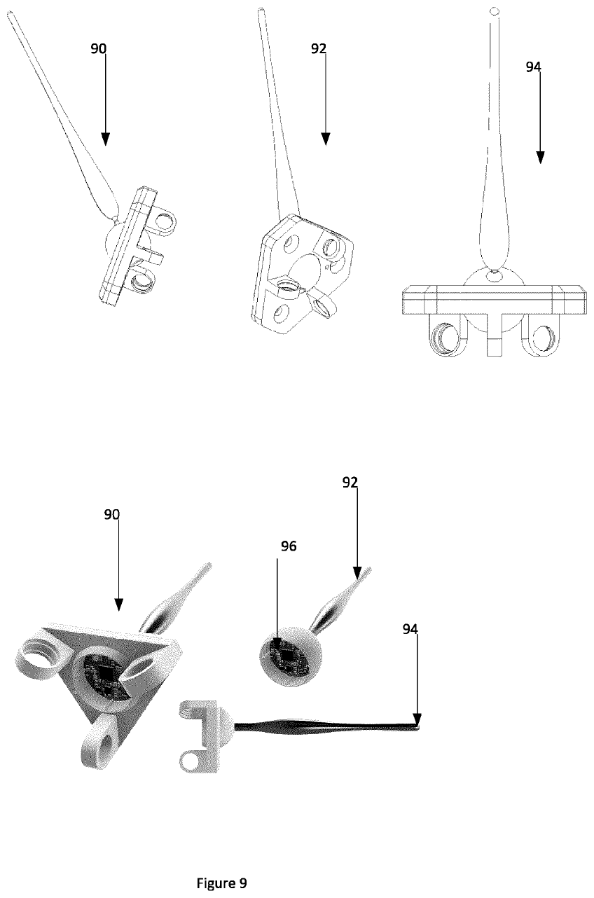

FIG. 9 is a schematic diagram of an end effector mount and stylus with orientation sensor. An end effector mount 90 is attached to the three distal linkages 22 to complete the delta formation of the haptic arms 18. The end effector mount 90 allows for any type of end effector to be attached depending on the haptic application. In the disclosed figures, a stylus 92 end effector is shown. At the base of the stylus 92, an end effector joint 94 interfaces with the end effector mount 90. The end effector joint 94 is a spherical shape to allow for free rotation within the end effector mount 90. The end effector joint 94 is made of a very low-friction material such as polytetrafluoroethylene (PTFE).

To determine the remaining three DOF for orientation, an orientation sensor 96 can be housed within the end effector joint 94. In the disclosed embodiment, an inertial measurement unit (IMU) is used as the orientation sensor. Based on readings from the accelerometer, gyroscope and magnetometer in the IMU, the roll, pitch and yaw can be calculated. The IMU is wirelessly connected, such as via Bluetooth®, to avoid tangling and friction from wires connecting the stylus 94 to the control board 34.

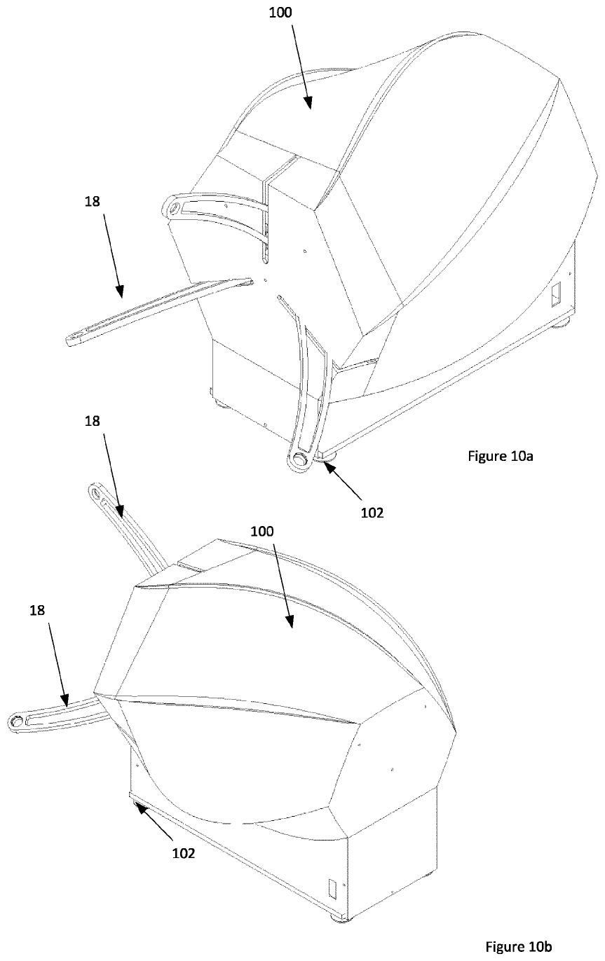

FIG. 1 is a perspective view of a haptic device including a housing, or shell, to encase the haptic device or components with proximal linkages extending out of the housing. FIG. 10 discloses an example embodiment for a housing 100 that encases the haptic system to protect all of the internal components and provide a barrier for safety. In the current embodiment, the housing is designed such that only the haptic arms 18 are visible and may also have a protruding power cord to plug in the device. In alternative embodiments, the device may be battery powered.

In some embodiments, the housing may also include feet 102 to seat the device on a surface. These feet 102 may be made out of a rubber or silicone material, and may apply suction to the surface for stability or the like. The illustrated embodiment shows the feet 102 on the base of the device, though they may also be mounted to the back plate such that the device can be oriented with the haptic arms 18 on top of the system or so that the haptic device may be mounted to a wall.

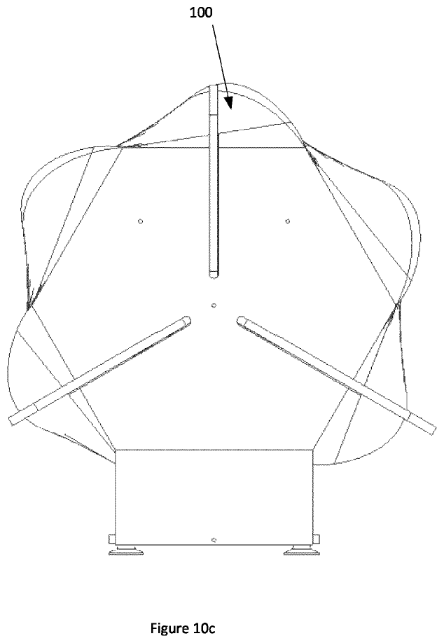

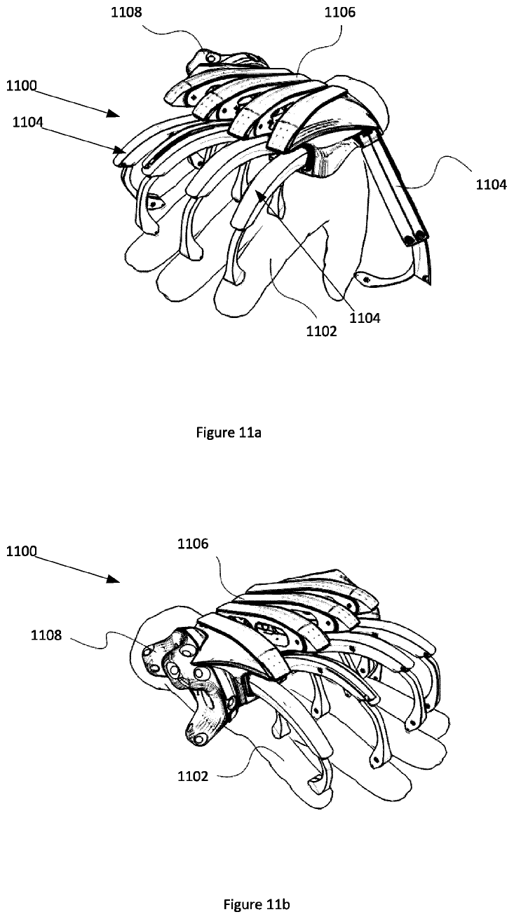

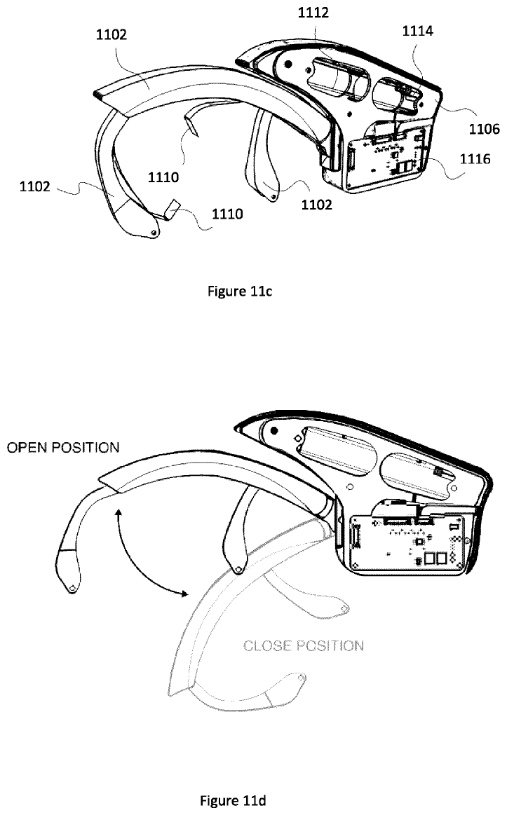

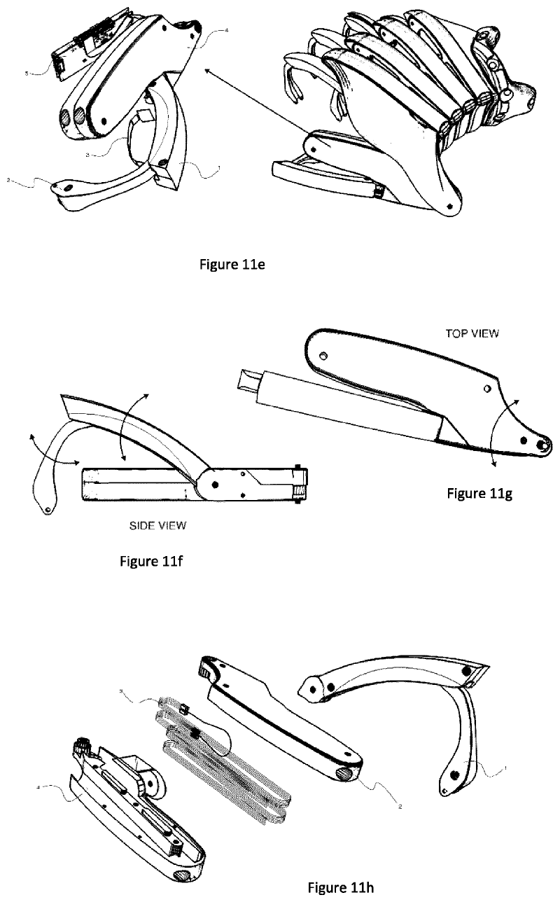

In a particular application of an embodiment of the disclosure, the haptic device may be a haptic glove or the like for use with a hand. Schematic diagrams of a haptic glove as shown in FIGS. 11a to 11h. In this embodiment, the system may include an inductive sensor that is integrated within or by flexible printed circuit boards (PCBs) for position measurement of the additional degrees of freedom. In this embodiment, the system may include software or modules that implement an embodiment of a method of operating the haptics device using SMA.

As shown in FIGS. 11a to 11h, a haptics device, such as the haptics glove device 1100 includes a glove 1102. A set of haptic arms 1104 are connected to the fingers of the glove 1102 to sense movement when a user's hand is placed within the glove 1102. The haptic arms 1104 are mounted to an actuator bracket, or housing, 1106. The device 1100 may further including a positioning sensor 1108 that is mounted to housing 1106.

As shown in FIG. 11c, the device 1100 may include different sensors 1110 that are connected to each linkage arm 1104. These sensors may include positioning sensors, accelerometers and the like. SMA wire bundles 1112, treated via multiple memory material processing to have multiple memories, connected to the linkage arms 1104 are located within the actuator housing 1106 and connected to SMA pulleys 1114 such as discussed above. A power control module 1116 is also located within the actuator housing 1106. FIG. 11d shows the glove device in open and closed positions.

In particular, the software or computer readable code may include algorithms to predict timing for heating SMA actuators, algorithms for using material properties (mass, stiffness/elasticity, damping coefficients) to simulate reaction forces of different material (I.e. foam, clay, elastic ball), algorithms or artificial intelligence for predicting material properties (i.e. neural networks); algorithms or artificial intelligence for gesture recognition with force feedback and/or algorithms for sensing control. In this embodiment, the device may make use of SMA materials in at least one of the following manners: wire bundle cut out of SMA sheets using lasers/EDM; using the slack of a detwinned martensite to achieve 0 force output to the hand during the return motion (which provides for two-way shape memory effect), possible use of high temperature and low hysteresis materials and implementing bundles to maximize, improve or increase frequency.

In the preceding description, for purposes of explanation, numerous details are set forth in order to provide a thorough understanding of the embodiments. However, it will be apparent to one skilled in the art that these specific details may not be required. In other instances, well-known structures may be shown in block diagram form in order not to obscure the understanding. For example, specific details are not provided as to whether aspects of the embodiments described herein are implemented as a software routine, hardware circuit, firmware, or a combination thereof.

Embodiments of the disclosure or portions/aspects thereof may be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

What is claimed is:

1. A haptics device comprising:
a set of haptic arms, each haptic arm including an actuating mechanism;
a set of shape memory alloy (SMA) components, each of the set of SMA components connected to one of the set of haptic arms to drive the actuating mechanism; and
a processor for communicating with each of the actuating mechanisms to actuate the set of haptic arms.

2. The haptics device of claim 1 wherein the set of SMA components comprise a SMA wire, a SMA bundle, a SMA spring or a thin SMA sheet.

3. The haptics device of claim 1 wherein when a current is passed through a SMA component, at least one portion of the SMA component experiences a microstructural transformation and at least one other portion of the SMA component remains unchanged.

4. The haptics device of claim 1 further comprising:
a set of cooling housings for cooling the set of SMA components.

5. The haptics device of claim 1 further comprising a set of positioning sensors for sensing a position of the set of haptic arms.

6. The haptics device of claim 2 wherein the SMA components are a SMA wire or SMA bundle.

7. The haptics device of claim 6 wherein the SMA wire bundle comprises crimps or swages at at least one end of the SMA wire bundle.

8. The haptics device of claim 6 wherein the SMA wire bundle comprises a first portion and a second portion.

9. The haptics device of claim 8 further comprising an electrical isolating component to isolate the first portion of the SMA wire bundle from the second portion of the SMA wire or SMA bundle.

10. The haptics device of claim 1 further comprising an end effector, the end effector connected to at least one of the set of haptic arms.

11. The haptics device of claim 10 further comprising a stylus component connected to the end effector.

12. The haptics device of claim 1 wherein each of the set of haptic arms comprises:
a proximal linkage; and
a distal linkage.

13. The haptics device of claim 1 wherein the set of SMA components are processed via multiple memory material technology to impart the multiple local transformation temperatures or enhance mechanical performance.

14. The haptics device of claim 1 wherein at least one of the set of SMA components includes multiple local transformation temperatures.

15. The haptics device of claim 1 wherein one portion of a SMA component actuates upon heating and another portion of the SMA component provides sensing.
